(19) United States
(12) Patent Application Publication
(10) Pub. No.: US 2015/0357144 A1
(43) Pub. Date: Dec. 10, 2015

(54) FUSE ASSEMBLY

(71) Applicant: HAMILTON SUNDSTRAND CORPORATION, Charlotte, NC (US)

(72) Inventor: Debabrata Pal, Hoffman Estates, IL (US)

(21) Appl. No.: 14/296,057

(22) Filed: Jun. 4, 2014

(51) Int. Cl. H01H 85/48

(52) U.S. Cl. CPC H01H 85/48

(57) ABSTRACT

A fuse assembly of a motor controller is provided. The fuse assembly includes a base, a base plate to which the base is attached, a lead frame that is attached to the base, at least one lead that is attached to the lead frame, and a fuse element attached to the base and covered with a fusible material. Heat is generated in the fuse element by a high flow of current carried by the assembly. The heat is operatively transferred through the assembly by direct conduction to the base and then base plate. The assembly sufficiently transfers heat to reduce rise in temperature of and properly cool the assembly. An operating temperature of the assembly is reduced to minimize or prevent damage thereto. The assembly has increased thermal-fatigue life and minimizes thermal-fatigue damage to the assembly during temperature cycling in an aircraft. Thermal stress of the assembly is minimized.

### BACKGROUND OF INVENTION

This invention relates, generally, to a motor controller and, more specifically, to a fuse assembly of a high-power motor controller for electrical-power generation/starting of an electric system of an aircraft.

A fuse assembly carrying a high flow of current (for example, about 26 A) is typically used in a motor controller. Such flow can cause generation of heat. In an exemplary assembly, an outer shell is pressed onto the assembly, and the assembly includes a fuse element that is fully encapsulated within a hard, rigid, compact, “sand-like” material. Sections of the fuse element are retained within one end of the assembly. The material does not fall loosely out of the assembly and restricts movement of the fuse element from thermal expansion. Heat is transferred from ends of the assembly.

If the assembly is not properly cooled, the heat can cause damage to and failure of the assembly and/or a fuse link thereof. Also, temperature cycling in an aircraft causes thermal-fatigue damage on the assembly.

Accordingly, it is desirable to provide a fuse assembly that sufficiently transfers heat to properly cool the assembly such that an operating temperature of the assembly is reduced to, thereby, minimize or prevent damage thereto. It is desirable also for thermal-fatigue damage during temperature cycling in an aircraft to be minimized or reduced as well.

### BRIEF DESCRIPTION OF INVENTION

According to a non-limiting embodiment of the invention, a fuse assembly of a motor controller is provided. The assembly includes a base, a base plate to which the base is attached, a lead frame that is attached to the base, at least one lead that is attached to the lead frame, and a fuse element attached to the base and covered with a fusible material. Heat is generated in the fuse element by a high flow of current carried by the assembly. The heat is operatively transferred through the assembly by way of direct conduction to the base and then to the base plate.

The fuse assembly sufficiently transfers heat to reduce rise in temperature of and properly cool the assembly, in general, and fuse element, in particular. In this way, an operating temperature of the assembly is reduced to, thereby, minimize or prevent damage thereto. Consequently, the assembly also has increased thermal-fatigue life and minimizes or reduces thermal-fatigue damage to the assembly during temperature cycling in an aircraft. Furthermore, thermal stress of the assembly is minimized.

### BRIEF DESCRIPTION OF DRAWING

The subject matter that is regarded as the invention is particularly pointed out and distinctly claimed in the claims at the conclusion of the specification. The foregoing and other features and advantages of the invention are apparent from the following detailed description taken in conjunction with the accompanying drawing in which:

FIG. 1 is a schematic perspective view of a non-limiting embodiment of a fuse assembly of a motor controller according to the invention.

FIG. 2 is a schematic cross-sectional view of the non-limiting embodiment of the fuse assembly of a motor controller according to the invention illustrated in FIG. 1.

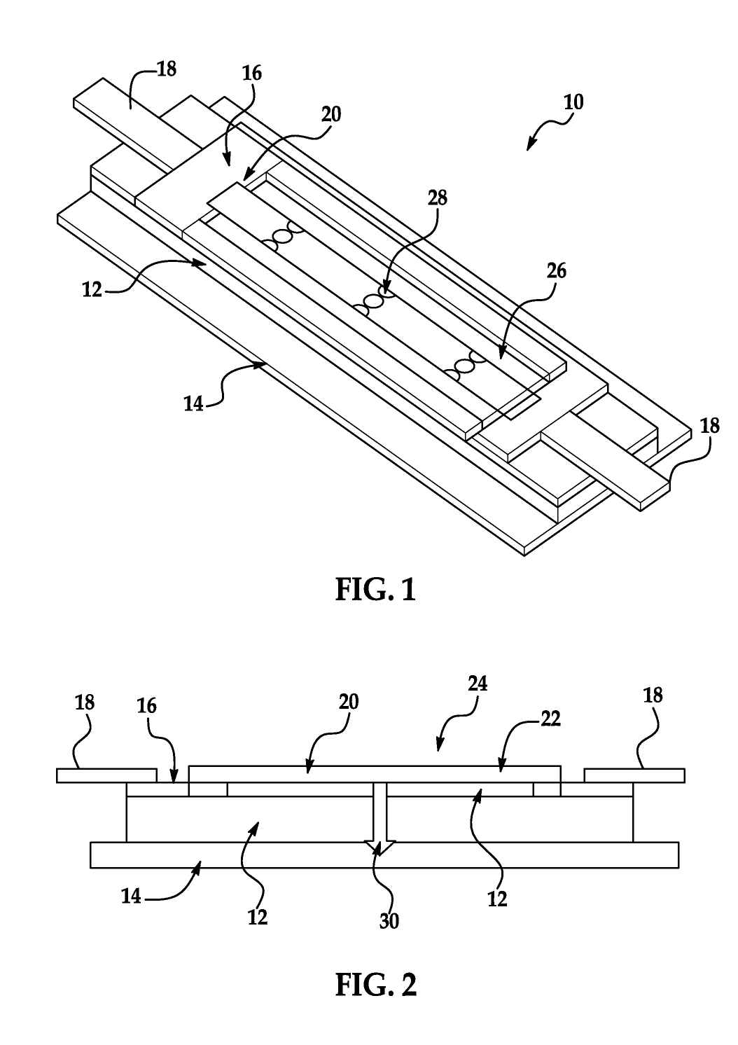

### DETAILED DESCRIPTION OF INVENTION

Referring now to the figures, a non-limiting embodiment of a fuse assembly according to the invention is shown at 10. Although the assembly 10 is disclosed herein as being implemented for a high-power motor controller for electrical-power generation/starting of an electric system of an aircraft, it should be appreciated that the assembly 10 can be implemented for any suitable type of motor controller. It should be appreciated also that the assembly 10 can be implemented for any suitable type of controller or even device.

As shown in the figures, the assembly 10 includes a base 12. In an aspect of the embodiment, the base 12 is made of ceramic. A coefficient of thermal expansion (CTE) of the base 12 can be about 20-22 micrometer/m-Deg C. Toward that end, the ceramic can be alumina (Al2O3) or boron nitride (BN).

The assembly 10 includes further a base plate 14 to which the base 12 is, in turn, attached. In an aspect, the base plate 14 is made of copper (Cu) and bonded to the base 12.

The assembly 10 includes further a lead frame 16 that is attached to the base 12. In an aspect, the lead frame 16 is bonded to the base 12 and made of copper (Cu).

The assembly 10 includes further at least one lead 18 that, in turn, is attached to the lead frame 16. In an aspect, a pair of leads 18 are attached to the lead frame 16.

The assembly 10 includes further a fuse element or link 20 that is attached to the base 12 and covered with a fusible material 22 (FIG. 2). In an aspect, the fuse element 20 is bonded to the base 12, and the fusible material 22 is silica 22. However, those having ordinary skill in the related art should appreciate that the fusible material 22 can be any suitable thermally conductive material (e.g., ceramic). The fuse element 20 also defines opposed ends of the fuse element 20 that are attached to the lead frame 16. In an aspect, the ends are soldered to the lead frame 16. A high flow of current (for example, about 26 A) carried by the assembly 10 generates heat in the fuse element 20.

The CTE of the fuse element 20 can be tailored to substantially match that of the base 12 to minimize thermal stress of the fuse assembly 10. Toward that end, the fuse element 20 can be made of copper (Cu), which has a CTE of about 16-20 micrometer/m-Deg C.

The assembly 10 includes further a cover 24 (FIG. 2) that is configured to create protection for the environment, a pocket 26 that is configured to be filled with ceramic and/or silica, and at least one fusible link 28 that is configured to constrict the high flow of current. In an aspect, three fusible links 28 are configured to constrict such flow.

The heat generated in the fuse element 20 by the high current flow is transferred through the assembly 10 as indicated at 30 in FIG. 2.

In operation of the assembly 10, the heat generated in the fuse element 20 is directly and, thus, very efficiently conducted or transferred to the base 12 and then to the base plate 14.

Those having ordinary skill in the related art should appreciate that the fuse assembly 10 can be made by any suitable combination of various additive manufacturing techniques, such as laser sintering.

The assembly 10 sufficiently operatively transfers heat to lower or reduce rise in temperature of and properly cool the assembly 10, in general, and fuse element 20, in particular. In this way, an operating temperature of the assembly 10 is reduced to, thereby, minimize or prevent damage to the assembly 10. Consequently, the assembly 10 also has increased thermal-fatigue life and minimizes or reduces thermal-fatigue damage to the assembly 10 during temperature cycling in an aircraft. Furthermore, thermal stress of the assembly 10 is minimized

While the invention has been described in detail in connection with only a limited number of embodiments, it should be readily understood that the invention is not limited to such disclosed embodiments. Rather, the invention can be modified to incorporate any number of variations, alterations, substitutions, or equivalent arrangements not heretofore described, but which are commensurate with the spirit and scope of the invention. Additionally, while various non-limiting embodiments of the invention have been described, it is to be understood that aspects of the invention may include only some of the described embodiments. Accordingly, the invention is not to be seen as limited by the foregoing description, but is only limited by the scope of the appended claims.

1. A fuse assembly comprising:
a base;
a base plate to which the base is attached;
a lead frame that is attached to the base;
at least one lead that is attached to the lead frame; and
a fuse element that is attached to the base and covered with a fusible material and in which heat is generated by a high flow of current carried by the assembly, wherein the heat is operatively transferred through the assembly by way of direct conduction to the base and then to the base plate.

2. The fuse assembly of claim 1, wherein the base is made of ceramic.

3. The fuse assembly of claim 1, wherein a coefficient of thermal expansion of the base is about 20-22 micrometer/m-Deg C.

4. The fuse assembly of claim 2, wherein the ceramic is either of alumina and boron nitride.

5. The fuse assembly of claim 2, wherein the base plate is made of copper.

6. The fuse assembly of claim 1, wherein the lead frame is made of copper.

7. The fuse assembly of claim 1, wherein a pair of leads are attached to the lead frame.

8. The fuse assembly of claim 1, wherein the fusible material is silica.

9. The fuse assembly of claim 1, wherein the fuse element defines opposed ends of the fuse element that are attached to the lead frame.

10. The fuse assembly of claim 3, wherein a coefficient of thermal expansion of the fuse element substantially matches that of the base.

11. The fuse assembly of claim 10, wherein the fuse element is made of copper.

12. The fuse assembly of claim 10, wherein the coefficient of thermal expansion of the fuse element is about 16-20 micrometer/m-Deg C.

13. The fuse assembly of claim 1, wherein the assembly comprises further a cover that is configured to create protection for the environment.

14. The fuse assembly of claim 1, wherein the assembly comprises further a pocket that is configured to be filled with at least one of ceramic and silica.

15. The fuse assembly of claim 1, wherein the assembly comprises further at least one fusible link that is configured to constrict the high flow of current.
